(19) United States
(12) Patent Application Publication
(10) Pub. No.: US 2020/0114219 A1
(43) Pub. Date: Apr. 16, 2020

(54) GOLF BALL

(71) Applicant: Bridgestone Sports Co., Ltd., Tokyo (JP)

(72) Inventors: Hideo WATANABE, Chichibushi (JP); Katsunori SATO, Chichibushi (JP)

(73) Assignee: Bridgestone Sports Co., Ltd., Tokyo (JP)

(21) Appl. No.: 16/586,123

(22) Filed: Sep. 27, 2019

(30) Foreign Application Priority Data
Oct. 10, 2018 (JP) 2018-191800

(51) Int. Cl. A63B 37/00; B29C 45/14

(52) U.S. Cl. CPC A63B 37/0087; A63B 37/0075; A63B 37/0092; A63B 37/0022; A63B 37/0084; B29K 2009/00; A63B 2037/0079; A63B 37/0096; A63B 37/0074; A63B 37/0076; B29C 45/14819

(57) ABSTRACT

A golf ball for amateur golfers is endowed with both an excellent flight and a good, soft feel at impact when hit by the average golfer whose head speed is not very high. The golf ball, which includes a core and a cover, has a compressive deformation A when subjected to a final load of 5 kgf from an initial load of 0.2 kgf that is 0.18 mm or less, a compressive deformation B when subjected to a final load of 50 kgf from an initial load of 5 kgf that is from 1.30 to 1.69 mm and a compressive deformation C when subjected to a final load of 90 kgf from an initial load of 5 kgf that is from 2.45 to 2.90 mm.

### CROSS-REFERENCE TO RELATED APPLICATION

This non-provisional application claims priority under 35 U.S.C. § 119(a) on Patent Application No. 2018-191800 filed in Japan on Oct. 10, 2018, the entire contents of which are hereby incorporated by reference.

### TECHNICAL FIELD

The present invention relates to a golf ball which has at least a core and a cover and is intended for use by amateur golfers having a head speed that is not fast.

### BACKGROUND ART

In the field of golf balls for amateur golfers, numerous balls intended to satisfy amateur golfers in terms of flight performance and feel at impact have hitherto been developed. For example, JP-A H8-280845 describes a golf ball in which the amount of compressive deformation by the ball when subjected to a final load of 5 kgf from an initial load state of 0.2 kgf is used as an indicator of the effects on the ball properties when a small impact force acts upon the ball, this value being set in the range of from 0.26 to 0.40 mm. However, this golf ball is a spin-type ball that is targeted primarily at the spin on approach shots, and does not fully satisfy the flight performance desired on shots with a driver.

In addition, a variety of functional, multi-piece solid golf balls in which the ball has a multilayer construction and the surface hardnesses of the respective layers—i.e., the core, intermediate layer and cover (outermost layer)—are optimized have been described. These include the multi-piece solid golf balls disclosed in JP-A 2005-211656, JP-A 2007-319666, JP-A 2001-218875, JP-A 2005-218858, JP-A 2008-212682 and JP-A 2009-195670. The golf balls disclosed in these patent publications are three-piece solid golf balls in which a material softer than the cover is disposed in the intermediate layer, and which provide an excellent flight performance even when used by amateur golfers having a head speed that is not fast. However, these prior-art golf balls do not optimize the amount of compressive deformation when subjected to a final load of 5 kgf from an initial load state of 0.2 kgf and the amount of compressive deformation when subjected to a final load of 50 kgf from an initial load state of 5 kgf. That is, no attention has been paid to how the golf ball properties are affected by the magnitude of the impact force acting on the ball, and so there remains room for improvement in obtaining a good flight performance and a good feel at impact in golf ball products for amateur golfers.

### SUMMARY OF THE INVENTION

It is therefore an object of the present invention to provide a golf ball for amateur golfers which has an excellent flight when hit by the average golfer whose head speed is not that high and which also has a good, soft feel at impact.

As a result of extensive investigations, we have focused on the relationship, in golf balls having a core and a cover, between the magnitude of the impact forces applied to the golf ball and the ball characteristics of flight performance and feel. We have discovered in particular that, in the amount of compressive deformation by the golf ball, by specifying the following respective compressive deformations: the compressive deformation A when the ball is subjected to a final load of 5 kgf from an initial load state of 0.2 kgf, the compressive deformation B when the ball is subjected to a final load of 50 kgf from an initial load state of 5 kgf, the compressive deformation C when the ball is subjected to a final load of 90 kgf from an initial load state of 5 kgf and the compressive deformation D when the ball is subjected to a final load of 130 kgf from an initial load state of 10 kgf, as well as the ratios therebetween, a flight performance that is satisfactory on full shots with a driver (W #1) or an iron can be fully obtained by golfers having a head speed that is not fast, in addition to which a good, soft feel can be obtained.

Accordingly, in a first aspect, the invention provides a golf ball that includes a core and a cover, wherein the ball has an amount of compressive deformation such that the compressive deformation A when the ball is subjected to a final load of 5 kgf from an initial load state of 0.2 kgf is 0.18 mm or less, the compressive deformation B when the ball is subjected to a final load of 50 kgf from an initial load state of 5 kgf is from 1.30 to 1.69 mm and the compressive deformation C when the ball is subjected to a final load of 90 kgf from an initial load state of 5 kgf is from 2.45 to 2.90 mm.

In a preferred embodiment of the golf ball according to the first aspect of the invention, the compressive deformation D when the ball is subjected to a final load of 130 kgf from an initial load state of 10 kgf is from 3.10 to 3.80 mm.

In another preferred embodiment, the compressive deformation E when the ball is subjected to a final load of 30 kgf from an initial load state of 5 kgf is from 0.68 to 0.98 mm.

The ratio D/A between compressive deformation D and compressive deformation A is preferably at least 18.0.

The ratio D/B between compressive deformation D and compressive deformation B is preferably from 2.15 to 2.40.

The ratio D/C between compressive deformation D and compressive deformation C is preferably from 1.26 to 1.31.

The ratio DIE between compressive deformation D and compressive deformation E is preferably from 3.65 to 4.10.

In yet another preferred embodiment, the ball further includes, between the core and the cover, at least an intermediate layer, thus having a construction of three or more layers that includes a core, an intermediate layer and a cover. In this embodiment, the golf ball preferably satisfies the following surface hardness relationship:

Shore C hardness at surface of cover>Shore C hardness at surface of intermediate layer>Shore C hardness at surface of core>Shore C hardness at center of core. (1)

In still another preferred embodiment of the inventive golf ball, the cover has a coating layer formed on a surface thereof, which coating layer has a material hardness that is higher than the hardness (Cc) at a center of the core.

In a further preferred embodiment, the golf ball satisfies the following initial velocity relationship:

initial velocity of intermediate layer-encased sphere>initial velocity of core>initial velocity of ball. (2)

In a second aspect, the invention provides a golf ball that includes a core and a cover, wherein the ball has an amount of compressive deformation such that, letting A be the compressive deformation when the ball is subjected to a final load of 5 kgf from an initial load state of 0.2 kgf, B be the compressive deformation when the ball is subjected to a final load of 50 kgf from an initial load state of 5 kgf, D be the compressive deformation when the ball is subjected to a final load of 130 kgf from an initial load state of 10 kgf and E be the compressive deformation when the ball is subjected to a final load of 30 kgf from an initial load state of 5 kgf, D has a value of from 3.10 to 3.80 mm, the ratio D/E is from 3.65 to 4.10, the ratio D/B is from 2.15 to 2.40 and the ratio D/A is at least 18.0.

In a preferred embodiment of the golf ball according to the second aspect of the invention, the ratio D/C between compressive deformation D and compressive deformation C is from 1.26 to 1.31.

### Advantageous Effects of the Invention

The golf ball of the invention has an excellent flight performance when hit by golfers whose head speeds are not that high and also has a good, soft feel at impact, making it highly suitable for use by amateur golfers.

### BRIEF DESCRIPTION OF THE DIAGRAMS

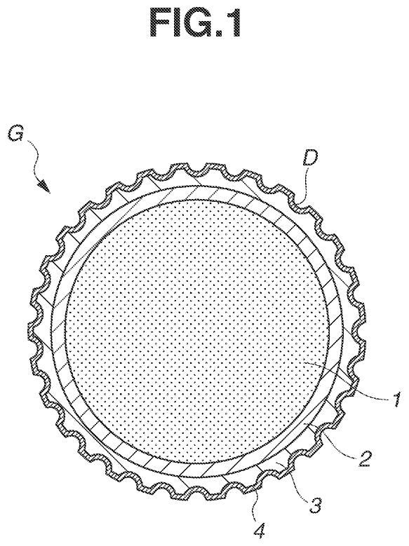

FIG. 1 is a schematic cross-sectional view of a golf ball having a three-layer construction according to one embodiment of the invention.

### DESCRIPTION OF THE PREFERRED EMBODIMENTS

The objects, features and advantages of the invention will become more apparent from the following detailed description taken in conjunction with the appended diagram.

The golf ball of the invention has a core and a cover. In this invention, the cover refers to the member positioned as the outermost layer in the ball construction and typically is formed by injection molding or the like. Numerous dimples are typically formed on the outer surface of the cover at the same time that the cover material is injection molded.

The core has a diameter of preferably at least 36.0 mm, more preferably at least 36.5 mm, and even more preferably at least 37.0 mm. The upper limit is preferably not more than 39.0 mm, more preferably not more than 38.5 mm, and even more preferably not more than 38.0 mm. When the core diameter is too small, the spin rate on shots with a driver (W #1) may become high, as a result of which it may not be possible to achieve the desired distance. On the other hand, when the core diameter is too large, the durability to repeated impact may worsen or the feel at impact may worsen.

The core has an amount of compressive deformation (mm) when subjected to a final load of 1,275 N (130 kgf) from an initial load of 98 N (10 kgf) which, although not particularly limited, is preferably at least 3.5 mm, more preferably at least 3.8 mm, and even more preferably at least 4.2 mm. The upper limit is preferably not more than 6.0 mm, more preferably not more than 5.3 mm, and even more preferably not more than 4.8 mm. When the compressive deformation of the core is too small, i.e., when the core is too hard, the spin rate of the ball may rise excessively and a good distance may not be achieved, or the feel at impact may be too hard. On the other hand, when the compressive deformation of the core is too large, i.e., when the core is too soft, the ball rebound may become too low and a good distance may not be achieved, the feel at impact may be too soft, or the durability to cracking on repeated impact may worsen.

The core is formed of a single layer or a plurality of layers of rubber material. A rubber composition can be prepared as this core-forming rubber material by using a base rubber as the chief component and including, together with this, other ingredients such as a co-crosslinking agent, an organic peroxide, an inert filler and an organosulfur compound. It is preferable to use polybutadiene as the base rubber.

Commercial products may be used as the polybutadiene. Illustrative examples include BR01, BR51 and BR730 (all products of JSR Corporation). The proportion of polybutadiene within the base rubber is preferably at least 60 wt %, and more preferably at least 80 wt %. Rubber ingredients other than the above polybutadienes may be included in the base rubber, provided that doing so does not detract from the advantageous effects of the invention. Examples of rubber ingredients other than the above polybutadienes include other polybutadienes and also other diene rubbers, such as styrene-butadiene rubbers, natural rubbers, isoprene rubbers and ethylene-propylene-diene rubbers.

Examples of co-crosslinking agents include unsaturated carboxylic acids and metal salts of unsaturated carboxylic acids. Specific examples of unsaturated carboxylic acids include acrylic acid, methacrylic acid, maleic acid and fumaric acid. The use of acrylic acid or methacrylic acid is especially preferred. Metal salts of unsaturated carboxylic acids are exemplified by, without particular limitation, the above unsaturated carboxylic acids that have been neutralized with desired metal ions. Specific examples include the zinc salts and magnesium salts of methacrylic acid and acrylic acid. The use of zinc acrylate is especially preferred.

The unsaturated carboxylic acid and/or metal salt thereof is included in an amount, per 100 parts by weight of the base rubber, which is typically at least 5 parts by weight, preferably at least 9 parts by weight, and more preferably at least 13 parts by weight. The amount included is typically not more than 60 parts by weight, preferably not more than 50 parts by weight, and more preferably not more than 40 parts by weight. Too much may make the core too hard, giving the ball an unpleasant feel at impact, whereas too little may lower the rebound.

Commercial products may be used as the organic peroxide. Examples of such products that may be suitably used include Percumyl D, Perhexa C-40 and Perhexa 3M (all from NOF Corporation), and Luperco 231XL (from AtoChem Co.). One of these may be used alone, or two or more may be used together. The amount of organic peroxide included to per 100 parts by weight of the base rubber is preferably at least 0.1 part by weight, more preferably at least 0.3 part by weight, even more preferably at least 0.5 part by weight, and most preferably at least 0.6 part by weight. The upper limit is preferably not more than 5 parts by weight, more preferably not more than 4 parts by weight, even more preferably not more than 3 parts by weight, and most preferably not more than 2.5 parts by weight. When too much or too little is included, it may not be possible to obtain a ball having a good feel, durability and rebound.

Another compounding ingredient typically included with the base rubber is an inert filler, preferred examples of which include zinc oxide, barium sulfate and calcium carbonate. One of these may be used alone, or two or more may be used together. The amount of inert filler included per 100 parts by weight of the base rubber is preferably at least 1 part by weight, and more preferably at least 5 parts by weight. The upper limit is preferably not more than 50 parts by weight, more preferably not more than 40 parts by weight, and even more preferably not more than 35 parts by weight. Too much or too little inert filler may make it impossible to obtain a proper weight and a suitable rebound.

In addition, an antioxidant may be optionally included. Illustrative examples of suitable commercial antioxidants include Nocrac NS-6 and Nocrac NS-30 (both available from Ouchi Shinko Chemical Industry Co., Ltd.), and Yoshinox 425 (available from Yoshitomi Pharmaceutical Industries, Ltd.). One of these may be used alone, or two or more may be used together.

The amount of antioxidant included per 100 parts by weight of the base rubber is set to 0 part by weight or more, preferably at least 0.05 part by weight, and more preferably at least 0.1 part by weight. The upper limit is set to preferably not more than 3 parts by weight, more preferably not more than 2 parts by weight, even more preferably not more than 1 part by weight, and most preferably not more than 0.5 part by weight. Too much or too little antioxidant may make it impossible to achieve a suitable ball rebound and durability.

An organosulfur compound may be included in the core in order to impart a good resilience. The organosulfur compound is not particularly limited, provided it can enhance the rebound of the golf ball. Exemplary organosulfur compounds include thiophenols, thionaphthols, halogenated thiophenols, and metal salts of these. Specific examples include pentachlorothiophenol, pentafluorothiophenol, pentabromothiophenol, p-chlorothiophenol, the zinc salt of pentachlorothiophenol, the zinc salt of pentafluorothiophenol, the zinc salt of pentabromothiophenol, the zinc salt of p-chlorothiophenol, and any of the following having 2 to 4 sulfur atoms: diphenylpolysulfides, dibenzylpolysulfides, dibenzoylpolysulfides, dibenzothiazoylpolysulfides and dithiobenzoylpolysulfides. The use of the zinc salt of pentachlorothiophenol is especially preferred.

The amount of organosulfur compound included per 100 parts by weight of the base rubber is 0 part by weight or more, and it is recommended that the amount be preferably at least 0.1 part by weight, and even more preferably at least 0.2 part by weight, and that the upper limit be preferably not more than 5 parts by weight, more preferably not more than 3 parts by weight, and even more preferably not more than 2 parts by weight. Including too much organosulfur compound may make a greater rebound-improving effect (particularly on shots with a W #1) unlikely to be obtained, may make the core too soft or may worsen the feel of the ball at impact. On the other hand, including too little may make a rebound-improving effect unlikely.

The core can be produced by vulcanizing and curing the rubber composition containing the above ingredients. For example, the core can be produced by using a Banbury mixer, roll mill or other mixing apparatus to intensively mix the rubber composition, subsequently compression molding or injection molding the mixture in a core mold, and curing the resulting molded body by suitably heating it under conditions sufficient to allow the organic peroxide or co-crosslinking agent to act, such as at a temperature of between 100 and 200° C., preferably between 140 and 180° C., for 10 to 40 minutes.

The core may consist of a single layer alone, or may be formed as a two-layer core consisting of an inner core layer and an outer core layer. When the core is formed as a two-layer core consisting of an inner core layer and an outer core layer, the inner core layer and outer core layer materials may each be composed primarily of the above-described rubber material. Also, the rubber material making up the outer core layer encasing the inner core layer may be the same as or different from the inner core layer material. The details here are the same as those given above for the ingredients of the core-forming rubber material.

Next, the core hardness profile is described.

The core center has a hardness (Cc) which, expressed on the Shore C hardness scale, is preferably at least 46, more preferably at least 48, and even more preferably at least 50. The upper limit is preferably not more than 63, more preferably not more than 60, and even more preferably not more than 58. When this value is too large, the feel at impact may become hard, or the spin rate on full shots may rise, as a result of which the intended distance may not be achieved. On the other hand, when this value is too small, the initial velocity of the ball when struck may be low, resulting in a poor distance, or the durability to cracking on repeated impact may worsen. The Shore C hardness is the hardness value measured with a Shore C durometer in general accordance with ASTM D2240. Although, for example, the timing of the read-off of measurements differs from that in the technique used for measuring JIS-C hardness, the measured Shore C hardness values do not differ much from and, in fact, are closely similar to the JIS-C values.

The core surface has a hardness (Cs) which, expressed on the Shore C hardness scale, is preferably at least 65, more preferably at least 68, and even more preferably at least 70. The upper limit is preferably not more than 88, more preferably not more than 84, and even more preferably not more than 80. A value outside of this range may lead to undesirable results similar to those described above for the core center hardness (Cc).

The difference between the core surface hardness (Cs) and the core center hardness (Cc), expressed on the Shore C hardness scale, is preferably at least 15, more preferably at least 17, and even more preferably at least 19. The upper limit is preferably not more than 35, more preferably not more than 30, and even more preferably not more than 25. When this value is too small, the ball spin rate-lowering effect on shots with a driver (W #1) may be inadequate, resulting in a poor distance. When this value is too large, the initial velocity of the ball when struck may decrease, resulting in a poor distance, or the durability to cracking on repeated impact may worsen.

Next, the cover is described.

The cover has a material hardness on the Shore D scale which, although not particularly limited, is preferably at least 54, more preferably at least 56, and even more preferably at least 58. The upper limit is preferably not more than 68, more preferably not more than 65, and even more preferably not more than 62. The surface hardness of the cover (also referred to herein as the “ball surface hardness”), expressed on the Shore D scale, is preferably at least 60, more preferably at least 62, and even more preferably at least 64. The upper limit is preferably not more than 74, more preferably not more than 71, and even more preferably not more than 68. When the material hardness of the cover and the ball surface hardness are lower than the above respective ranges, the spin rate of the ball on shots with a driver (W #1) may rise and the ball initial velocity may decrease, as a result of which a good distance may not be achieved. On the other hand, when the material hardness of the cover and the ball surface hardness are too high, the durability to cracking on repeated impact may worsen.

The cover has a thickness of preferably at least 0.6 mm, more preferably at least 0.8 mm, and even more preferably at least 1.1 mm. The upper limit in the cover thickness is preferably not more than 1.8 mm, more preferably not more than 1.6 mm, and even more preferably not more than 1.4 mm. When the cover is too thin, the durability to cracking on repeated impact may worsen. When the cover is too thick, the spin rate of the ball on shots with a driver (W #1) may rise excessively and a good distance may not be achieved, or the feel at impact in the short game and on shots with a putter may be too hard.

Various types of thermoplastic resins, particularly ionomer resins, that are employed in golf ball cover stock may be suitably used as the cover material. Commercial products may be used as the ionomer resin. Alternatively, the cover-forming resin material that is used may be one obtained by blending, of commercially available ionomer resins, a high-acid ionomer resin having an acid content of at least 18 wt % into a conventional ionomer resin. When the content of the high-acid ionomer resin is too high, the durability to cracking on repeated impact may worsen.

An intermediate layer may be provided between the core and the cover. That is, suitable ball constructions in the present invention are not limited to two-piece golf balls having a core and a single-layer cover; three-piece golf balls and four-piece golf balls may also be used. The use of golf balls composed of three layers—a core, an intermediate layer and a cover—is especially suitable. Such golf balls are exemplified by the golf ball G shown in FIG. 1. The golf ball G in FIG. 1 has a core 1, an intermediate layer 2 encasing the core 1, and a cover 3 encasing the intermediate layer 2. This cover 3 is positioned as the outermost layer, aside from a coating layer, in the layer structure of the golf ball. The intermediate layer may be a single layer or may be formed of two or more layers. Numerous dimples D are generally formed on the surface of the cover (outermost layer) 3 in order to enhance the aerodynamic properties. In addition, a coating layer 4 is formed on the surface of the cover 3.

Next, the intermediate layer is described.

The intermediate layer has a material hardness on the Shore D scale which, although not particularly limited, is preferably at least 50, more preferably at least 52, and even more preferably at least 55. The upper limit is preferably not more than 62, more preferably not more than 60, and even more preferably not more than 58. The surface hardness of the sphere obtained by encasing the core with the intermediate layer (intermediate layer-encased sphere), expressed on the Shore D scale, is preferably at least 56, more preferably at least 58, and even more preferably at least 61. The upper limit is preferably not more than 68, more preferably not more than 66, and even more preferably not more than 64. When the material and surface hardnesses of the intermediate layer are lower than the above respective ranges, the spin rate of the ball on full shots may rise excessively, resulting in a poor distance, or the durability of the ball to repeated impact may worsen. On the other hand, when the material and surface hardnesses are too high, the durability to cracking on repeated impact may worsen or the desired feel at impact may worsen.

The intermediate layer has a thickness of preferably at least 0.7 mm, more preferably at least 0.9 mm, and even more preferably at least 1.1 mm. The upper limit in the intermediate layer thickness is preferably not more than 1.6 mm, more preferably not more than 1.5 mm, and even more preferably not more than 1.4 mm. When the intermediate layer is too thin, the durability to cracking on repeated impact may worsen or the feel at impact may worsen. When the intermediate layer is too thick, the spin rate of the ball on full shots may rise and a good distance may not be obtained.

The intermediate layer-forming material is not particularly limited and may be a known resin. Examples of preferred materials include resin compositions containing as the essential ingredients:

100 parts by weight of a resin component composed of, in admixture,

(A) a base resin of (a-1) an olefin-unsaturated carboxylic acid random copolymer and/or a metal ion neutralization product of an olefin-unsaturated carboxylic acid random copolymer mixed with (a-2) an olefin-unsaturated carboxylic acid-unsaturated carboxylic acid ester random terpolymer and/or a metal ion neutralization product of an olefin-unsaturated carboxylic acid-unsaturated carboxylic acid ester random terpolymer in a weight ratio between 100:0 and 0:100, and

(B) a non-ionomeric thermoplastic elastomer in a weight ratio between 100:0 and 50:50;

(C) from 5 to 120 parts by weight of a fatty acid and/or fatty acid derivative having a molecular weight of from 228 to 1,500; and

(D) from 0.1 to 17 parts by weight of a basic inorganic metal compound capable of neutralizing un-neutralized acid groups in components A and C.

Components A to D in the intermediate layer-forming resin material described in, for example, JP-A 2010-253268 may be advantageously used as above components A to D.

A non-ionomeric thermoplastic elastomer may be included in the intermediate layer material. The amount of non-ionomeric thermoplastic elastomer included is preferably from 0 to 50 parts by weight per 100 parts by weight of the total amount of the base resin.

Exemplary non-ionomeric thermoplastic elastomers include polyolefin elastomers (including polyolefin and metallocene polyolefins), polystyrene elastomers, diene polymers, polyacrylate polymers, polyamide elastomers, polyurethane elastomers, polyester elastomers and polyacetals.

Depending on the intended use, optional additives may be suitably included in the intermediate layer material. For example, pigments, dispersants, antioxidants, ultraviolet absorbers and light stabilizers may be added. When these additives are included, the amount added per 100 parts by weight of the overall base resin is preferably at least 0.1 part by weight, and more preferably at least 0.5 part by weight. The upper limit is preferably not more than 10 parts by weight, and more preferably not more than 4 parts by weight.

The sphere obtained by encasing the core with the intermediate layer (intermediate layer-encased sphere) has an amount of compressive deformation when subjected to a final load of 1,275 N (130 kgf) from an initial load of 98 N (10 kgf) which, although not particularly limited, is preferably at least 3.5 mm, more preferably at least 3.7 mm, and even more preferably at least 3.9 mm. The upper limit is preferably not more than 4.7 mm, more preferably not more than 4.5 mm, and even more preferably not more than 4.3 mm. When the compressive deformation of the sphere is too small, that is, when the sphere is too hard, the ball spin rate may rise excessively, resulting in a poor distance, or the feel at impact may become too hard. On the other hand, when the compressive deformation of the sphere is too large, that is, when the sphere is too soft, the ball rebound may become too low, resulting in a poor distance, the feel at impact may become too soft, or the durability to cracking on repeated impact may worsen.

The manufacture of multi-piece solid golf balls in which the above-described core, intermediate layer and cover (outermost layer) are formed as successive layers may be carried out by a customary method such as a known injection molding process. For example, a multi-piece golf ball can be obtained by injection-molding the intermediate layer material over the core so as to obtain an intermediate layer-encased sphere, and then injection-molding the cover material over the intermediate layer-encased sphere. Alternatively, the encasing members, i.e., the intermediate layer and the cover, may each be formed by enclosing the core or intermediate layer-encased sphere within two half-cups that have been pre-molded into hemispherical shapes and then molding under applied heat and pressure.

The compressive deformation A of the inventive golf ball when subjected to a final load of 5 kgf from an initial load state of 0.2 kgf is 0.18 mm or less, preferably 0.17 mm or less, and more preferably 0.16 mm or less. The lower limit is preferably at least 0.10 mm, and more preferably at least 0.12 mm. When this value becomes smaller, in cases where the smaller value is attributable to the cover hardness, the cover may be too hard and the durability of the ball to cracking under repeated impact may worsen. Alternatively, when the value becomes smaller owing to compression of an inner layer, the feel of the ball on full shots may become too hard. On the other hand, when the above value becomes larger, in cases where the larger value is attributable to the cover hardness, the spin rate of the ball on full shots may end up rising, so that a good distance is not achieved. Alternatively, when the value becomes larger owing to compression of an inner layer, the initial velocity of the ball when struck on a full shot may decrease and a good distance may not be achieved.

The compressive deformation B of the inventive golf ball when subjected to a final load of 50 kgf from an initial load state of 5 kgf is preferably at least 1.30 mm, more preferably at least 1.40 mm, and even more preferably at least 1.45 mm. The upper limit is preferably not more than 1.69 mm, more preferably not more than 1.67 mm, and even more preferably not more than 1.65 mm. When this value is small, the ball may have too hard a feel when hit with an iron or the spin rate may rise and a good distance may not be achieved. On the other hand, when this value is large, the initial velocity of the ball on shots with an iron may diminish and a good distance may not be achieved.

The compressive deformation C of the inventive golf ball when subjected to a final load of 90 kgf from an initial load state of 5 kgf is preferably at least 2.45 mm, more preferably at least 2.50 mm, and even more preferably at least 2.55 mm. The upper limit is preferably not more than 2.90 mm, more preferably not more than 2.87 mm, and even more preferably not more than 2.85 mm. When this value is small, the spin rate of the ball may rise and a good distance may not be achieved, or the feel at impact may become too hard. On the other hand, when this value is large, the initial velocity of the ball when hit may become too low, resulting in a poor distance, the feel at impact may become too soft, or the durability of the ball to cracking on repeated impact may worsen.

The compressive deformation D of the inventive golf ball when subjected to a final load of 130 kgf from an initial load state of 10 kgf is preferably at least 3.10 mm, more preferably at least 3.15 mm, and even more preferably at least 3.20 mm. The upper limit is preferably not more than 3.80 mm, more preferably not more than 3.70 mm, and even more preferably not more than 3.60 mm. When this value is small, the spin rate of the ball may rise and a good distance may not be achieved, or the feel at impact may become too hard. On the other hand, when this value is large, the initial velocity of the ball when hit may become too low, resulting in a poor distance, the feel at impact may become too soft, or the durability of the ball to cracking on repeated impact may worsen.

The compressive deformation E of the inventive golf ball when subjected to a final load of 30 kgf from an initial load state of 5 kgf is preferably at least 0.68 mm, more preferably at least 0.75 mm, and even more preferably at least 0.81 mm. The upper limit is preferably not more than 0.98 mm, more preferably not more than 0.96 mm, and even more preferably not more than 0.94 mm. When this value is small, the feel of the ball when struck with an iron may become too hard or the spin rate may rise, as a result of which a good distance may not be obtained. On the other hand, when this value is large, the initial velocity of the ball when struck with an iron may decrease and a good distance may not be achieved.

The ratio D/A between compressive deformation D and compressive deformation A is preferably at least 18.0, more preferably at least 20.0, and even more preferably at least 22.0. The upper limit is preferably not more than 24.5, and more preferably not more than 23.5. Outside of this range, the ball may become too receptive to spin or the initial velocity of the ball when struck may decrease and impact conditions under which the distance falls may arise.

The ratio D/B between compressive deformation D and compressive deformation B is preferably at least 2.15, more preferably at least 2.16, and even more preferably at least 2.18. The upper limit is preferably not more than 2.40, more preferably not more than 2.35, and even more preferably not more than 2.30. Outside of this range, the spin rate of the ball may increase and impact conditions under which the distance falls may arise.

The ratio D/C between compressive deformation D and compressive deformation C is preferably at least 1.26, and more preferably at least 1.27. The upper limit is preferably not more than 1.31, more preferably not more than 1.30, and even more preferably not more than 1.29. Outside of this range, the spin rate of the ball may increase and impact conditions under which the distance falls may arise.

The ratio D/E between compressive deformation D and compressive deformation E is preferably at least 3.65, more preferably at least 3.70, and even more preferably at least 3.75. The upper limit is preferably not more than 4.10, more preferably not more than 4.08, and even more preferably not more than 4.06. Outside of this range, the spin rate of the ball may increase and impact conditions under which the distance falls may arise.

### Surface Hardness Relationships Among Layers

In this invention, it is desirable for the hardness relationships among the layers to satisfy formula (1) below:

Shore C hardness at cover surface>Shore C hardness at intermediate layer surface>Shore C hardness at core surface>Shore C hardness at core center. (1)

Here, the hardness at the cover surface refers to the surface hardness of the ball, and the hardness at the intermediate layer surface refers to the surface hardness of the intermediate layer-encased sphere.

When the above hardness relationship is not satisfied, it may not be possible to achieve both a good flight performance and a soft feel at impact.

As indicated in the above formula, the cover surface hardness is higher than the intermediate layer surface hardness. The difference therebetween, i.e., the “cover surface hardness−intermediate layer surface hardness” value, expressed on the Shore C hardness scale, is preferably from 13 to 33, more preferably from 17 to 30, and even more preferably from 20 to 27. When this value is small, the spin rate of the ball on full shots may end up rising, as a result of which a good distance may not be achieved, or the feel at impact may worsen. On the other hand, when this value is large, the initial velocity of the ball when struck may decrease, resulting in a poor distance, or the durability to cracking on repeated impact may worsen.

As indicated in the above formula, the intermediate layer surface hardness is higher than the core surface hardness. The difference therebetween, i.e., the “intermediate layer surface hardness−core surface hardness” value, expressed on the Shore C hardness scale, is preferably from 1 to 27, more preferably from 13 to 25, and even more preferably from 15 to 23. When this value is small, the spin rate of the ball may rise, as a result of which a good distance may not be achieved. On the other hand, when this value is large, the feel at impact may worsen or the durability to cracking on repeated impact may worsen.

As indicated in the above formula, the core surface hardness is higher than the core center hardness. The relationship between the core surface hardness (Cs) and the core center hardness (Cc) is as described above.

### Compressive Deformation Relationships Among Encased Spheres

Letting O and M be the respective compressive deformations (mm) of the core and the intermediate layer-encased sphere when subjected to a final load of 1,275 N (130 kg) from an initial load of 98 N (10 kgf), the value O−M is preferably from 0.1 to 0.8 mm, more preferably from 0.2 to 0.7 mm, and even more preferably from 0.3 to 0.6 mm. When this value is small, the spin rate of the ball may increase, as a result of which a good distance may not be achieved. When this value is large, the feel at impact may worsen or the durability to repeated impact may worsen.

Letting O and D be the respective compressive deformations (mm) of the core and the ball when subjected to a final load of 1,275 N (130 kg) from an initial load of 98 N (10 kgf), the value O−D is preferably from 0.5 to 1.7 mm, more preferably from 0.7 to 1.4 mm, and even more preferably from 0.9 to 1.2 mm. When this value is small, the spin rate of the ball may rise, as a result of which a good distance may not be achieved. On the other hand, when this value is large, the initial velocity of the ball on shots with a driver (W #1) may become low and a good distance may not be obtained, or the durability to cracking on repeated impact may worsen.

### Initial Velocity Relationships Among Encased Spheres

The “intermediate layer-encased sphere initial velocity−core initial velocity” value is preferably from −0.3 to 0.5 m/s, more preferably from −0.2 to 0.4 m/s, and even more preferably from 0 to 0.3 m/s. When this value is too small, the spin rate-lowering effect on full shots may be inadequate, as a result of which a good distance may not be achieved. On the other hand, when this value is too large, the intermediate layer material may become brittle and the durability to cracking on repeated impact may worsen.

The “ball initial velocity−intermediate layer-encased sphere initial velocity” value is preferably from −0.7 to 0.4 m/s, more preferably from −0.6 to 0 m/s, and even more preferably from −0.5 to −0.4 ms. When this value is too large, the cover may become hard, as a result of which the durability to cracking on repeated impact may worsen. On the other hand, when this value is too small, the cover may become soft, as a result of which the spin rate on full shots may rise, resulting in a poor distance, or the feel at impact may worsen.

The “ball initial velocity−core initial velocity” value is preferably from −0.8 to 0 m/s, more preferably from −0.6 to −0.1 m/s, and even more preferably from −0.5 to −0.2 m/s. When this value is too small, the rebound of the overall ball may become low or the spin rate on full shots may rise excessively, as a result of which a good distance may not be obtained. On the other hand, when this value is too large, the cover may become hard and the durability to cracking on repeated impact may worsen.

As used herein. “initial velocity” refers to the initial velocity of the various spheres—i.e., the core, the intermediate layer-encased sphere and the ball—as measured by the method, set forth in the Rules of Golf, for measuring the initial velocity of golf balls using an initial velocity measuring apparatus of the same type as the USGA drum rotation-type initial velocity instrument.

Numerous dimples may be formed on the outside surface of the cover serving as the outermost layer. The number of dimples arranged on the cover surface, although not particularly limited, is preferably at least 250, more preferably at least 300, and even more preferably at least 320. The upper limit is preferably not more than 380, more preferably not more than 350, and even more preferably not more than 340. When the number of dimples is higher than this range, the ball trajectory may become lower, as a result of which the distance traveled by the ball may decrease. On the other hand, when the number of dimples is lower that this range, the ball trajectory may become higher, as a result of which a good distance may not be achieved.

The dimple shapes used may be of one type or may be a combination of two or more types suitably selected from among, for example, circular shapes, various polygonal shapes, dewdrop shapes and oval shapes. When circular dimples are used, the dimple diameter may be set to at least about 2.5 mm and up to about 6.5 mm, and the dimple depth may be set to at least 0.08 mm and up to 0.30 mm.

In order for the aerodynamic properties to be fully manifested, it is desirable for the dimple coverage ratio on the spherical surface of the golf ball, i.e., the dimple surface coverage SR, which is the sum of the individual dimple surface areas, each defined by the flat plane circumscribed by the edge of a dimple, as a percentage of the spherical surface area of the ball were the ball to have no dimples thereon, to be set to at least 70% and not more than 90%. Also, to optimize the ball trajectory, it is desirable for the value V₀, defined as the spatial volume of the individual dimples below the flat plane circumscribed by the dimple edge, divided by the volume of the cylinder whose base is the flat plane and whose height is the maximum depth of the dimple from the base, to be set to at least 0.35 and not more than 0.80. Moreover, it is preferable for the ratio VR of the sum of the volumes of the individual dimples, each formed below the flat plane circumscribed by the edge of a dimple, with respect to the volume of the ball sphere were the ball surface to have no dimples thereon, to be set to at least 0.6% and not more than 1.0%. Outside of the above ranges in these respective values, the resulting trajectory may not enable a good distance to be obtained and so the ball may fail to travel a fully satisfactory distance.

To ensure a good ball appearance, it is preferable to apply a clear coating onto the cover surface. The coating composition used in clear coating is preferably one which uses two types of polyester polyol as the base resin and uses a polyisocyanate as the curing agent. In this case, various organic solvents can be admixed depending on the intended coating conditions. Examples of organic solvents that can be used include aromatic solvents such as toluene, xylene and ethylbenzene; ester solvents such as ethyl acetate, butyl acetate, propylene glycol methyl ether acetate and propylene glycol methyl ether propionate; ketone solvents such as acetone, methyl ethyl ketone, methyl isobutyl ketone and cyclohexanone; ether solvents such as diethylene glycol dimethyl ether, diethylene glycol diethyl ether and dipropylene glycol dimethyl ether; alicyclic hydrocarbon solvents such as cyclohexane, methyl cyclohexane and ethyl cyclohexane; and petroleum hydrocarbon-based solvents such as mineral spirits.

The coating layer obtained by clear coating has a hardness which, on the Shore C hardness scale, is preferably from 40 to 80, more preferably from 47 to 72, and even more preferably from 55 to 65. When the coating layer is too soft, mud may tend to stick to the surface of the ball when used for golfing. On the other hand, when the coating layer is too hard, it may tend to peel off when the ball is struck.

The “core center hardness (Cc)−coating layer hardness” value on the Shore C hardness scale is preferably from −18 to 5, more preferably from −15 to 0, and even more preferably from −12 to −5. When this value falls outside of the above range, the spin rate of the ball on full shots may rise, as a result of which a good distance may not be achieved.

The coating layer has a thickness of typically from 9 to 22 μm, preferably from 11 to 20 μm, and more preferably from 13 to 18 μm. When the coating layer is thinner than this range, the cover protecting effect may be inadequate. On the other hand, when the coating layer is thicker than this range, the dimple shapes may no longer be sharp, as a result of which a good distance may not be achieved.

The multi-piece solid golf ball of the invention can be made to conform to the Rules of Golf for play. The inventive ball may be formed to a diameter which is such that the ball does not pass through a ring having an inner diameter of 42.672 mm and is not more than 42.80 mm, and to a weight which is preferably between 45.0 and 45.93 g.

### EXAMPLES

The following Examples and Comparative Examples are provided to illustrate the invention, and are not intended to limit the scope thereof.

### Examples 1 to 4. Comparative Examples 1 to 5

### Formation of Core

Solid cores were produced by preparing rubber compositions for the respective Examples and Comparative Examples shown in Table 1, and then molding/vulcanizing the compositions under vulcanization conditions of 155° C. and 15 minutes.

TABLE 1

| Core formulation | Example | | | | Comparative Example | | | | |
|---|---|---|---|---|---|---|---|---|---|
| (pbw) | 1 | 2 | 3 | 4 | 1 | 2 | 3 | 4 | 5 |
| Polybutadiene A | 80 | 80 | 80 | 80 | 80 | 95 | 95 | 100 | 100 |
| Polybutadiene B | 20 | 20 | 20 | 20 | 20 | | | | |
| Isoprene rubber | | | | | | 5.0 | 5.0 | | |
| Zinc acrylate | 20.0 | 19.7 | 19.6 | 19.7 | 20.8 | 25.3 | 27.0 | 22.8 | 25.0 |
| Organic peroxide (1) | 0.6 | 0.6 | 0.6 | 0.6 | 0.6 | 0.6 | 0.6 | 0.6 | 0.6 |
| Organic peroxide (2) | 0.6 | 0.6 | 0.6 | 0.6 | 0.6 | 0.6 | 0.6 | 0.6 | 0.6 |
| Zinc stearate | | | | | | | | | 5.0 |
| Antioxidant | 0.1 | 0.1 | 0.1 | 0.1 | 0.1 | 0.1 | 0.1 | 0.1 | 0.1 |
| Barium sulfate | 17.9 | 28.0 | 28.1 | 28.0 | 27.6 | 26.0 | 25.3 | | |
| Zinc oxide | 4.0 | 4.0 | 4.0 | 4.0 | 4.0 | 4.0 | 4.0 | 21.7 | 20.3 |
| Zinc salt of pentachlorothiophenol | 0.2 | 0.2 | 0.2 | 0.2 | 0.2 | | | 1.0 | 1.0 |

Details on the ingredients mentioned in Table 1 are given below.
Polybutadiene A: Available under the trade name “BR 01” from JSR Corporation
Polybutadiene B: Available under the trade name “BR 51” from JSR Corporation
Isoprene Rubber: Available under the trade name “IR2200” from JSR Corporation
Zinc acrylate: Available as “ZN-DA85S” from Nippon Shokubai Co., Ltd.
Organic Peroxide (1): Dicumyl peroxide, available under the trade name “Percumyl D” from NOF Corporation
Organic Peroxide (2): A mixture of 1,1-di(t-butylperoxy)cyclohexane and silica, available under the trade name “Perhexa C-40” from NOF Corporation
Zinc stearate: Available as “Zinc Stearate G” from NOF Corporation
Antioxidant: 2,2′-Methylenebis(4-methyl-6-butylphenol), available under the trade name “Nocrac NS-6” from Ouchi Shinko Chemical Industry Co., Ltd.
Barium sulfate: Baryte powder available as “Barico #100” from Hakusui Tech
Zinc oxide: Available as “Zinc Oxide Grade 3” from Sakai Chemical Co., Ltd.
Zinc salt of pentachlorothiophenol:
   Available from Wako Pure Chemical Industries, Ltd.

### Formation of Intermediate Layer

Next, in each Example and Comparative Example other than Comparative Example 4 and Comparative Example 5, an intermediate layer was formed by injection molding the intermediate layer material formulated as shown in Table 2 over the core, thereby giving a sphere encased by the intermediate layer.

### Formation of Cover (Outermost Layer)

Next, in each Example and Comparative Example other than Comparative Example 4 and Comparative Example 5, a cover (outermost layer) was formed by injection molding the cover material formulated as shown in Table 2 over the intermediate layer-encased sphere obtained as described above. In Comparative Examples 4 and 5, the cover (outermost layer) was formed by injection molding the cover material directly over the core. Also, a plurality of given dimples common to all the Examples and Comparative Examples were formed on the surface of the cover.

TABLE 2

| Resin composition (pbw) | I | II | III | IV | V | VI | VII | VII |
|---|---|---|---|---|---|---|---|---|
| Himilan 1605 | 44 | 36 | | | 50 | 50 | | |
| Himilan 1557 | | | | | | | 37.5 | 42.5 |
| Himilan 1601 | | | | | | | 37.5 | 42.5 |
| AM7329 | | | | | 15 | 50 | | |
| Surlyn 9320 | | | | | 35 | | | |
| AN4319 | | | | | | | 25 | 15 |
| HPF 1000 | 56 | 64 | | 100 | | | | |
| HPF 2000 | | | 100 | | | | | |
| Titanium oxide | | | | | 4 | 4 | 4 | 4 |

Trade names of the chief materials mentioned in the table are given below.
Himilan, AM7329: Ionomers available from DuPont-Mitsui Polychemicals Co., Ltd.
Surlyn: An ionomer available from E.I. DuPont de Nemours & Co.
AN4319: Available under the trade name “Nucrel” from DuPont-Mitsui Polychemicals Co., Ltd.
HPF 1000: DuPont™ HPF 1000
HPF 2000: DuPont™ HPF 2000
Titanium oxide: Available from Sakai Chemical Industry Co., Ltd.

### Formation of Coating Layer

Next, the coating formulated as shown in Table 3 below was applied with an air spray gun onto the surface of the cover (outermost layer) on which numerous dimples had been formed, thereby producing golf balls having a 15 μm-thick coating layer formed thereon.

TABLE 3

| | | | |
|---|---|---|---|
| Coating C | Base resin | Polyol | 29.77 |
| composition (pbw) | | Additive | 0.22 |
| | | Solvent | 70.01 |
| | Curing agent | Isocyanate | 42 |
| | | Solvent | 58 |

| | | |
|---|---|---|
| Coating layer properties | Shore C hardness | 62.5 |
| | Thickness (μm) | 15 |

A polyester polyol synthesized as follows was used as the polyol in the base resin.

A reactor equipped with a reflux condenser, a dropping funnel, a gas inlet and a thermometer was charged with 140 parts by weight of trimethylolpropane, 95 parts by weight of ethylene glycol, 157 parts by weight of adipic acid and 58 parts by weight of 1,4-cyclohexanedimethanol, following which the temperature was raised to between 200 and 240° C. under stirring and the reaction was effected by 5 hours of heating. This yielded a polyester polyol having an acid value of 4, a hydroxyl value of 170 and a weight-average molecular weight (Mw) of 28.000. The additives were water repellent additives. All the additives used were commercial products. Products that were silicone-based additives, stain resistance-improving silicone additives, or fluoropolymers having an alkyl group chain length of 7 or less were added.

The isocyanate used in the curing agent was Duranate™ TPA-100 (from Asahi Kasei Corporation; NCO content, 23.1%; 100% nonvolatiles), an isocyanurate of hexamethylene diisocyanate (HMDI).

Butyl acetate was used as the base resin solvent, and ethyl acetate and butyl acetate were used as the curing agent solvents. The Shore C hardness values in the table were obtained by preparing sheets having a thickness of 2 mm, stacking together three such sheets, and carrying out measurement with a Shore C durometer in general accordance with ASTM D2240.

Various properties of the resulting golf balls, including the core center and surface hardnesses, the diameters of the core and the respective layer-encased spheres, the thickness and material hardness of each layer, and the surface hardness, initial velocity and compressive deformation under specific loading of the respective layer-encased spheres were evaluated by the following methods. The results are presented in Table 4.

### Diameters of Core and Intermediate Layer-Encased Sphere

The diameters at five random places on the surface were measured after holding the core or intermediate layer-encased sphere isothermally at a temperature of 23.9±1 C for at least three hours and, using the average of these measurements as the measured value for a single core or intermediate layer-encased sphere, the average diameter for ten test specimens was determined.

### Diameter of Ball

The diameters at 15 random dimple-free areas on the surface of a ball were measured after isothermally holding the ball at a temperature of 23.91° C. for at least three hours and, using the average of these measurements as the measured value for a single ball, the average diameter for ten measured balls was determined.

Compressive Deformations of Core. Intermediate Layer-Encased Sphere and Ball

A core, intermediate layer-encased sphere or ball was placed on a hard plate and the compressive deformation A of the ball when subjected to a final load of 5 kgf from an initial load of 0.2 kgf the compressive deformation B of the ball when subjected to a final load of 50 kgf from an initial load of 5 kgf, the compressive deformation C of the ball when subjected to a final load of 90 kgf from an initial load of 5 kgf, the compressive deformation D of the ball when subjected to a final load of 130 kgf from an initial load of 10 kgf, the compressive deformation E of the ball when subjected to a final load of 30 kgf from an initial load of 5 kgf, the compressive deformation M of the intermediate layer-encased sphere when subjected to a final load of 130 kgf from an initial load of 10 kgf and the compressive deformation O of the core when subjected to a final load of 130 kgf from an initial load of 10 kgf were each measured. These compressive deformations refer in each case to a measured value obtained after holding the test specimen isothermally at 23.9° C. The instrument used was a high-load compression tester available from MU Instruments Trading Corporation. Measurement was carried out with the pressing head moving downward at a speed of 4.7 mm/sec.

### Core Hardness Profile

The indenter of a durometer was set substantially perpendicular to the spherical surface of the core, and the surface hardness of the core on the Shore C hardness scale was measured in accordance with ASTM D2240. The hardness at the center of the core was measured by perpendicularly pressing the indenter of a durometer against the center region of the flat cross-section obtained by cutting the core into hemispheres. The measurement results are indicated as Shore C hardness values.

### Material Hardnesses (Shore D Hardnesses) of Intermediate Layer and Cover

The resin materials for each of these layers were molded into sheets having a thickness of 2 mm and left to stand for at least two weeks, following which the Shore D hardnesses were measured in accordance with ASTM D2240.

### Surface Hardnesses (Shore D and Shore C Hardnesses) of Intermediate Layer-Encased Sphere and Ball

Measurements were taken by pressing the durometer indenter perpendicularly against the surface of each sphere. The surface hardness of the ball (cover) is the measured value obtained at dimple-free places (lands) on the ball surface. The Shore D hardnesses were measured with a type D durometer in accordance with ASTM D2240, and the Shore C hardnesses were measured with a type C durometer in accordance with ASTM D2240.

### Initial Velocities of Core, Intermediate Layer-Encased Sphere and Ball

The initial velocity was measured using an initial velocity measuring apparatus of the same type as the USGA drum rotation-type initial velocity instrument approved by the R&A. The cores, intermediate layer-encased spheres and balls (referred to collectively below as the “test spheres”) were tested in a chamber at a room temperature of 23.9±2° C. after being held isothermally in a 23.9±1° C. environment for at least 3 hours. Each test sphere was hit using a 250-pound (113.4 kg) head (striking mass) at an impact velocity of 143.8 ft/s (43.83 m/s). One dozen test spheres were each hit four times. The time taken for the test sphere to traverse a distance of 6.28 ft (1.91 m) was measured and used to compute the initial velocity (m/s). This cycle was carried out over a period of about 15 minutes.

TABLE 4

| | | | Example | | | | Comparative Example | | | | |
|---|---|---|---|---|---|---|---|---|---|---|---|
| | | | 1 | 2 | 3 | 4 | 1 | 2 | 3 | 4 | 5 |
| Construction | | | 3-piece | 3-piece | 3-piece | 3-piece | 3-piece | 3-piece | 3-piece | 2-piece | 2-piece |
| Core | Diameter (mm) | | 37.4 | 37.2 | 37.3 | 37.2 | 37.4 | 37.3 | 37.3 | 39.6 | 39.3 |
| | Weight (g) | | 32.5 | 32.5 | 32.5 | 32.5 | 32.5 | 32.7 | 32.6 | 37.5 | 36.8 |
| | Compressive deformation O (mm) | | 4.4 | 4.5 | 4.6 | 4.5 | 4.2 | 3.3 | 3.2 | 4.3 | 4.4 |
| | Initial velocity (m/s) | | 77.5 | 77.8 | 77.8 | 77.8 | 77.4 | 76.7 | 76.5 | 77.8 | 77.5 |
| Core | Surface hardness (Cs) | Shore C | 75.7 | 72.8 | 70.0 | 72.8 | 76.0 | 79.8 | 85.9 | 73.8 | 73.4 |
| hardness | Center hardness (Cc) | | 56.7 | 53.8 | 51.0 | 53.8 | 57.0 | 59.8 | 65.9 | 59.5 | 59.0 |
| profile | Surface hardness − Center | | 19.0 | 19.0 | 19.0 | 19.0 | 19.0 | 20.0 | 20.0 | 14.3 | 14.4 |
| | hardness (Cs − Cc) | | | | | | | | | | |
| Inter- | Material | | I | I | I | II | III | IV | I | — | — |
| meditate | Thickness (mm) | | 1.3 | 1.4 | 1.4 | 1.4 | 1.3 | 1.4 | 1.4 | — | — |
| layer | Material hardness (sheet hardness: | | 57.0 | 57.0 | 57.0 | 56.0 | 47.0 | 50.0 | 57.0 | — | — |
| | Shore D) | | | | | | | | | | |
| Inter- | Diameter (mm) | | 40.0 | 40.0 | 40.0 | 40.0 | 40.0 | 40.0 | 40.0 | — | — |
| meditate | Weight (g) | | 38.7 | 38.8 | 38.7 | 38.8 | 38.7 | 38.8 | 38.8 | — | — |
| layer- | Compressive deformation | | 3.9 | 4.1 | 4.3 | 4.1 | 4.0 | 3.1 | 2.8 | — | — |
| encased | M (mm) | | | | | | | | | | |
| sphere | Initial velocity (m/s) | | 77.8 | 77.8 | 77.8 | 77.8 | 77.4 | 77.3 | 77.0 | — | — |
| | Surface hardness | Shore D | 61.8 | 61.4 | 61.6 | 59.9 | 53.0 | 57.8 | 61.8 | — | — |
| | Surface hardness | Shore C | 91.6 | 91.4 | 91.5 | 91.7 | 81.2 | 89.2 | 93.3 | — | — |
| Intermediate layer surface hardness − | | Shore C | 16.0 | 18.6 | 21.6 | 18.9 | 5.1 | 9.4 | 7.5 | — | — |
| Core surface hardness | | | | | | | | | | | |
| Difference in compressive deformation between core | | | 0.5 | 0.4 | 0.3 | 0.4 | 0.2 | 0.2 | 0.3 | — | — |
| and intermediate layer-encased sphere: O − M (mm) | | | | | | | | | | | |
| Initial velocity of intermediate layer-encased sphere - | | | 0.3 | 0.0 | 0.0 | 0.0 | 0.0 | 0.6 | 0.4 | — | — |
| Initial velocity of core (m/s) | | | | | | | | | | | |
| Cover | Material | | V | V | V | V | V | VI | VI | VII | VIII |
| | Thickness (mm) | | 1.4 | 1.3 | 1.4 | 1.3 | 1.4 | 1.4 | 1.4 | 1.6 | 1.7 |
| | Material hardness | | 59.0 | 59.0 | 59.0 | 59.0 | 59.0 | 63.0 | 63.0 | 56.0 | 58.0 |
| | (sheet hardness: Shore D) | | | | | | | | | | |
| | Material hardness | | 88.2 | 88.2 | 88.2 | 88.2 | 88.2 | 93.4 | 93.4 | 84.2 | 86.8 |
| | (Sheet hardness: Shore C) | | | | | | | | | | |
| Coating | Material | | Coating | Coating | Coating | Coating | Coating | Coating | Coating | Coating | Coating |
| layer | | | C | C | C | C | C | C | C | C | C |
| | Material hardness | | 62.5 | 62.5 | 62.5 | 62.5 | 62.5 | 62.5 | 62.5 | 62.5 | 62.5 |
| | (sheet hardness: Shore C) | | | | | | | | | | |
| Core center hardness − | | Shore C | −5.8 | −8.7 | −11.6 | −8.7 | −5.5 | −2.7 | 3.4 | −3.0 | −3.5 |
| Material hardness of coating layer | | | | | | | | | | | |
| Ball | Diameter (mm) | | 42.7 | 42.7 | 42.7 | 42.7 | 42.7 | 42.7 | 42.7 | 42.7 | 42.7 |
| | Weight (g) | | 45.3 | 45.4 | 45.3 | 45.3 | 45.4 | 45.4 | 45.4 | 45.4 | 45.4 |
| | Compressive deformation (A) | | 0.14 | 0.15 | 0.16 | 0.16 | 0.17 | 0.11 | 0.11 | 0.26 | 0.27 |
| | under 0.2 to 5 kgf loading (mm) | | | | | | | | | | |
| | Compressive deformation (E) | | 0.81 | 0.88 | 0.94 | 0.90 | 1.01 | 0.66 | 0.54 | 1.18 | 1.11 |
| | under 5 to 30 kgf loading (mm) | | | | | | | | | | |
| | Compressive deformation (B) | | 1.43 | 1.54 | 1.65 | 1.58 | 1.70 | 1.18 | 0.94 | 1.92 | 1.84 |
| | under 5 to 50 kgf loading (mm) | | | | | | | | | | |
| | Compressive deformation (C) | | 2.55 | 2.70 | 2.84 | 2.77 | 2.85 | 2.10 | 1.77 | 3.09 | 2.97 |
| | under 5 to 90 kgf loading (mm) | | | | | | | | | | |
| | Compressive deformation (D) | | 3.28 | 3.44 | 3.60 | 3.50 | 3.55 | 2.71 | 2.33 | 3.79 | 3.69 |
| | under 10 to 130 kgf loading (mm) | | | | | | | | | | |
| | Initial velocity (m/s) | | 77.3 | 77.3 | 77.3 | 77.3 | 77.2 | 77.6 | 77.2 | 77.4 | 77.2 |
| | Surface hardness | Shore D | 65.0 | 65.0 | 65.0 | 65.0 | 65.0 | 69.0 | 69.0 | 62.0 | 64.0 |
| | Surface hardness | Shore C | 96.1 | 96.1 | 96.1 | 96.1 | 96.1 | 100.0 | 100.0 | 92.1 | 94.7 |

| | | | | | | | | | | |
|---|---|---|---|---|---|---|---|---|---|---|
| Ball surface hardness − Core surface hardness | Shore C | 20.4 | 23.3 | 26.1 | 23.3 | 20.1 | 20.2 | 14.2 | 18.3 | 21.4 |
| Ball surface hardness − | Shore C | 4.5 | 4.7 | 4.6 | 4.4 | 14.9 | 10.8 | 6.7 | — | — |
| Intermediate layer surface hardness | | | | | | | | | | |

| | | | | | | | | | |
|---|---|---|---|---|---|---|---|---|---|
| Difference in compressive deformation between core | 1.1 | 1.1 | 1.0 | 1.0 | 0.6 | 0.6 | 0.8 | 0.5 | 0.7 |
| and ball: O − D (mm) | | | | | | | | | |
| Ball initial velocity - Core initial velocity (m/s) | −0.2 | −0.5 | −0.5 | −0.4 | −0.2 | 0.9 | 0.7 | −0.4 | −0.3 |
| Ball initial velocity - | −0.5 | −0.5 | −0.5 | −0.4 | −0.2 | 0.3 | 0.2 | — | — |
| Intermediate layer-encased sphere initial velocity (m/s) | | | | | | | | | |
| Compressive deformation ratio D/A | 22.8 | 22.9 | 23.1 | 22.5 | 20.9 | 24.7 | 21.8 | 14.5 | 13.6 |
| Compressive deformation ratio D/B | 2.30 | 2.24 | 2.18 | 2.22 | 2.10 | 2.30 | 2.48 | 1.98 | 2.01 |
| Compressive deformation ratio D/C | 1.29 | 1.28 | 1.27 | 1.27 | 1.25 | 1.29 | 1.32 | 1.23 | 1.24 |
| Compressive deformation ratio D/E | 4.04 | 3.92 | 3.82 | 3.90 | 3.53 | 4.13 | 4.33 | 3.22 | 3.32 |

The flight performance and feel at impact of each golf ball were evaluated by the following methods. The results are shown in Table 6.

### Flight Performance

Various clubs (W #1, I #6) were mounted on a golf swing robot and the distances traveled by the balls when struck under the conditions shown in Table 5 below were measured and rated according to the criteria in the table.

TABLE 5

| | | W#1 | W#1 | I#6 |
|---|---|---|---|---|
| Club used | Product name | PHYZ | PHYZ | PHYZ |
| | Conditions | HS, 40 m/s | HS, 35 m/s | HS, 35 m/s |
| Rating | Good | ≥200.0 m | ≥181.0 m | ≥140.3 in |
| criteria | NG | ≤199.9 m | ≤180.9 m | ≤140.2 tn |

Regarding the club name “PHYZ” in the above table, the PHYZ Driver (loft angle, 10.5°) and PHYZ Iron I #6, both manufactured by Bridgestone Sports Co., Ltd., were used.

### Feel

Sensory evaluations were carried out when the balls were hit with a driver (W #1) by amateur golfers having head speeds of 30 to 40 m/s. The balls were rated for “soft feel” according to the following criteria.

Good: Twelve or more out of 20 golfers rated the ball as having a soft feel

Fair: From 7 to 11 out of 20 golfers rated the ball as having a soft feel

NG: Six or fewer out of 20 golfers rated the ball as having a soft feel

TABLE 6

| | | | Example | | | | Comparative Example | | | | |
|---|---|---|---|---|---|---|---|---|---|---|---|
| | | | 1 | 2 | 3 | 4 | 1 | 2 | 3 | 4 | 5 |
| Flight | W#1 | Spin rate (rpm) | 2,769 | 2,685 | 2,682 | 2,679 | 2,665 | 2,757 | 2,999 | 2,655 | 2,689 |
| | HS, | Total distance (m) | 200.8 | 201.8 | 201.9 | 201.9 | 201.0 | 203.5 | 197.9 | 197.9 | 198.5 |
| | 40 m/s | Rating | good | good | good | good | good | good | NG | NG | NG |
| | W#1 | Spin rate (rpm) | 2,756 | 2,692 | 2,680 | 2,668 | 2,677 | 2,873 | 3,100 | 2,578 | 2,695 |
| | HS, | Total distance (m) | 181.4 | 182.7 | 182.2 | 181.6 | 182.3 | 183.6 | 178.8 | 181.9 | 181.5 |
| | 35 m/s | Rating | good | good | good | good | good | good | NG | good | good |
| | I#6 | Spin rate (rpm) | 5,100 | 5,048 | 5,048 | 5,048 | 5,230 | 5,647 | 5,755 | 5,061 | 5,112 |
| | | Total distance (m) | 140.9 | 141.4 | 141.5 | 141.6 | 139.9 | 137.4 | 136.2 | 138.5 | 138.9 |
| | | Rating | good | good | good | good | NG | NG | NG | NG | NG |
| Feel | Soft | Rating | good | good | good | good | good | NG | NG | good | good |
| | feel | | | | | | | | | | |

As demonstrated by the results in Table 6, the golf balls of Comparative Examples 1 to 5 were inferior in the following respects to the golf balls according to the present invention that were obtained in the Examples.

In Comparative Example 1, the compressive deformation B when the ball was subjected to a final load of 50 kgf from an initial load state of 5 kgf was a value larger than 1.69 mm. As a result, the spin rate of the ball when struck with a number six iron (I #6) increased and the distance achieved by the ball was inferior.

In Comparative Example 2, compressive deformation B was smaller than 1.30 mm and the compressive deformation C when the ball was subjected to a final load of 90 kgf from an initial load state of 5 kgf was a value smaller than 2.45 mm. As a result, the spin rate of the ball when struck with a number six iron (I #6) increased and the distance achieved by the ball was inferior. Moreover, a sufficiently soft feel was not obtained.

In Comparative Example 3, compressive deformation B was smaller than 1.30 mm and compressive deformation C was smaller than 2.45 mm. As a result, the spin rate of the ball when struck with a number six iron (I #6) increased and the distance achieved by the ball was inferior. Moreover, a sufficiently soft feel was not obtained.

In Comparative Example 4, compressive deformation B was larger than 1.69 mm, compressive deformation C was larger than 2.90 mm and the compressive deformation A when the ball was subjected to a final load of 5 kgf from an initial load state of 0.2 kgf was a value larger than 0.18 mm. As a result, the initial velocities of the ball when struck with a driver (W #1) and a number six iron (I #6) were low and the distances achieved by the ball were inferior.

In Comparative Example 5, compressive deformation B was larger than 1.69 mm, compressive deformation C was larger than 2.90 mm and compressive deformation A was larger than 0.18 mm. As a result, the initial velocities of the ball when struck with a driver (W #1) and a number six iron (I #6) were low and the distance achieved by the ball was inferior.

### Comparative Examples 6 to 11

In each of Comparative Examples 6 to 11 below, various compressive deformations of the golf ball products shown in Table 7 below were measured in the same way as in the above examples. The flight performance and feel of each golf ball were evaluated by the same methods as in the above examples. These compressive deformations and ball properties are shown in the same table. The golf balls in Comparative Examples 7, 8 and 11 were two-piece solid golf balls having a single-layer core and a cover. The golf balls in Comparative Examples 6, 9 and 10 were three-piece solid golf balls having a single-layer core, an intermediate layer and a cover.

Details on the commercial golf balls used in Comparative Examples 6 to 11 are shown below.
Comparative Example 6: Titleist ProV 1 (2017 model), from the Acushnet Company
Comparative Example 7: Titleist TourSoft (2018 model), from the Acushnet Company
Comparative Example 8: Titleist VELOCITY (2018 model), from the Acushnet Company
Comparative Example 9: Callaway SUPERHOT 70 (2017 model), from the Callaway Golf Company
Comparative Example 10: VOLVIK VIVID (2016 model), from VOLVIK
Comparative Example 11: Wilson Staff DUO SOFT (2018 model), from Wilson Sporting Goods

TABLE 7

| | | | Comparative Example | | | | | |
|---|---|---|---|---|---|---|---|---|
| | | | 6 | 7 | 8 | 9 | 10 | 11 |
| Product name | | | Titleist | Titleist | Titleist | Callaway | VOLVIK | Wilson |
| | | | ProV1 | TourSoft | VELOCITY | SUPERHOT | VIVID | Staff DUO |
| | | | | | | 70 | | SOFT |
| Construction | | | 3-piece | 2-piece | 2-piece | 3-piece | 3-piece | 2-piece |
| Compressive | Compressive deformation A | | 0.19 | 0.18 | 0.19 | 0.21 | 0.15 | 0.33 |
| deformation | under 0.2 to 5 kgf loading (mm) | | | | | | | |
| of ball | Compressive deformation E | | 0.76 | 0.99 | 0.87 | 0.91 | 0.77 | 1.34 |
| | under 5 to 30 kgf loading (mm) | | | | | | | |
| | Compressive deformation B | | 1.23 | 1.61 | 1.43 | 1.44 | 1.26 | 2.13 |
| | under 5 to 50 kgf loading (mm) | | | | | | | |
| | Compressive deformation C | | 2.04 | 2.63 | 2.43 | 2.39 | 2.15 | 3.43 |
| | under 5 to 90 kgf loading (mm) | | | | | | | |
| | Compressive deformation D | | 2.56 | 3.29 | 3.08 | 2.99 | 2.72 | 4.26 |
| | under 10 to 130 kgf loading (mm) | | | | | | | |
| Compressive deformation ratio D/A | | | 13.5 | 18.1 | 16.3 | 14.0 | 17.5 | 12.9 |
| Compressive deformation ratio D/B | | | 2.09 | 2.04 | 2.14 | 2.08 | 2.16 | 2.00 |
| Compressive deformation ratio D/C | | | 1.25 | 1.25 | 1.26 | 1.25 | 1.26 | 1.24 |
| Compressive deformation ratio D/E | | | 3.35 | 3.31 | 3.52 | 3.29 | 3.53 | 3.18 |
| Flight | W#1 | Spin rate (rpm) | 3,058 | 2,778 | 2,705 | 2,755 | 2,777 | 2,500 |
| | HS, 40 m/s | Total distance (m) | 202.2 | 201.3 | 202.9 | 205.1 | 200.3 | 199.8 |
| | | Rating | good | good | good | good | good | NG |
| | W#1 | Spin rate (rpm) | 2,976 | 2,683 | 2,698 | 2,748 | 2,732 | 2,459 |
| | HS, 35 m/s | Total distance (m) | 181.6 | 181.2 | 182.8 | 182.0 | 180.5 | 181.7 |
| | | Rating | good | good | good | good | NG | good |
| | I#6 | Spin rate (rpm) | 5,981 | 5,768 | 5,448 | 5,249 | 5,513 | 5,463 |
| | | Total distance (m) | 136.5 | 136.7 | 139.0 | 139.2 | 138.1 | 136.9 |
| | | Rating | NG | NG | NG | NG | NG | NG |
| Feel | Soft feel | Rating | NG | good | NG | NG | NG | good |

As demonstrated by the results in Table 7, the golf balls of Comparative Examples 6 to 11 were inferior in the following respects to the golf balls according to the present invention that were obtained in the Examples.

In Comparative Example 6, compressive deformation A was larger than 0.18 mm, compressive deformation B was smaller than 1.30 mm and compressive deformation C was smaller than 2.45 mm. As a result, the spin rate of the ball when struck with a number six iron (I #6) rose and the distance achieved by the ball was inferior. In addition, a sufficiently soft feel was not obtained.

In Comparative Example 7, compressive deformation B was larger than 1.69 mm. As a result, the spin rate of the ball when struck with a number six iron (I #6) rose and the distance achieved by the ball was inferior.

In Comparative Example 8, compressive deformation A was larger than 0.18 mm and compressive deformation C was smaller than 2.45. As a result, the spin rate of the ball when struck with a number six iron (I #6) rose and the distance achieved by the ball was inferior. In addition, a sufficiently soft feel was not obtained.

In Comparative Example 9, compressive deformation A was larger than 0.18 mm and compressive deformation C was smaller than 2.45. As a result, the spin rate of the ball when struck with a number six iron (I #6) rose and the distance achieved by the ball was inferior. In addition, a sufficiently soft feel was not obtained.

In Comparative Example 10, compressive deformation B was smaller than 1.30 mm and compressive deformation C was smaller than 2.45. As a result, the spin rate of the ball when struck with a number six iron (I #6) rose and the distance achieved by the ball was inferior. In addition, a sufficiently soft feel was not obtained.

In Comparative Example 11, compressive deformation A was larger than 0.18, compressive deformation B was larger than 1.69 mm and compressive deformation C was larger than 2.90. As a result, the initial velocity of the ball when struck was low and the distances achieved on shots with a driver (W #1) and a number six iron (I #6) were inferior.

Japanese Patent Application No. 2018-191800 is incorporated herein by reference.

Although some preferred embodiments have been described, many modifications and variations may be made thereto in light of the above teachings. It is therefore to be understood that the invention may be practiced otherwise than as specifically described without departing from the scope of the appended claims.

1. A golf ball comprising a core and a cover, wherein the ball has an amount of compressive deformation such that the compressive deformation A when the ball is subjected to a final load of 5 kgf from an initial load state of 0.2 kgf is 0.18 mm or less, the compressive deformation B when the ball is subjected to a final load of 50 kgf from an initial load state of 5 kgf is from 1.30 to 1.69 mm and the compressive deformation C when the ball is subjected to a final load of 90 kgf from an initial load state of 5 kgf is from 2.45 to 2.90 mm.

2. The golf ball of claim 1, wherein the compressive deformation D when the ball is subjected to a final load of 130 kgf from an initial load state of 10 kgf is from 3.10 to 3.80 mm.

3. The golf ball of claim 1, wherein the compressive deformation E when the ball is subjected to a final load of 30 kgf from an initial load state of 5 kgf is from 0.68 to 0.98 mm.

4. The golf ball of claim 2, wherein the ratio D/A between compressive deformation D and compressive deformation A is at least 18.0.

5. The golf ball of claim 2, wherein the ratio D/B between compressive deformation D and compressive deformation B is from 2.15 to 2.40.

6. The golf ball of claim 2, wherein the ratio D/C between compressive deformation D and compressive deformation C is from 1.26 to 1.31.

7. The golf ball of claim 3, wherein the ratio D/E between compressive deformation D and compressive deformation E is from 3.65 to 4.10.

8. The golf ball of claim 1, wherein the ball further comprises, between the core and the cover, at least an intermediate layer, which golf ball has a construction of three or more layers that includes a core, an intermediate layer and a cover.

9. The golf ball of claim 8 which satisfies the following surface hardness relationship:
Shore C hardness at surface of cover>Shore C hardness at surface of intermediate layer>Shore C hardness at surface of core>Shore C hardness at center of core. (1)

10. The golf ball of claim 1, wherein the cover has a coating layer formed on a surface thereof, which coating layer has a material hardness that is higher than the hardness (Cc) at a center of the core.

11. The golf ball of claim 1 which satisfies the following initial velocity relationship:
initial velocity of intermediate layer-encased sphere>initial velocity of core>initial velocity of ball. (2)

12. A golf ball comprising a core and a cover, wherein the ball has an amount of compressive deformation such that, letting A be the compressive deformation when the ball is subjected to a final load of 5 kgf from an initial load state of 0.2 kgf, B be the compressive deformation when the ball is subjected to a final load of 50 kgf from an initial load state of 5 kgf, D be the compressive deformation when the ball is subjected to a final load of 130 kgf from an initial load state of 10 kgf and E be the compressive deformation when the ball is subjected to a final load of 30 kgf from an initial load state of 5 kgf, D has a value of from 3.10 to 3.80 mm, the ratio D/E is from 3.65 to 4.10, the ratio D/B is from 2.15 to 2.40 and the ratio D/A is at least 18.0.

13. The golf ball of claim 12, wherein the ratio D/C between compressive deformation D and compressive deformation C is from 1.26 to 1.31.
